(19) United States
(12) Patent Application Publication
(10) Pub. No.: US 2020/0353598 A1
(43) Pub. Date: Nov. 12, 2020

(54) Straight Edge Clamping Device

(71) Applicant: Eugene K. Emerson, Whittier, CA (US)

(72) Inventor: Eugene K. Emerson, Whittier, CA (US)

(21) Appl. No.: 16/408,460

(22) Filed: May 9, 2019

(51) Int. Cl. B25B 5/16; B23Q 3/10; B23Q 3/06; B25B 5/00

(52) U.S. Cl. CPC B25B 5/163; B23Q 3/105; B25B 5/02; B25B 5/006; B23Q 3/06

(57) ABSTRACT

A clamping device has a clamp surface with a base jaw and a countering jaw attached to a clamp surface. The base jaw has one or more through holes from its front base face to its rear base face so that a base accessory may be attached to the base jaw using the through holes in the base jaw. Likewise, the countering jaw also has one or more through holes from its front countering face to its rear countering face so that a countering accessory may be attached to the countering jaw using the through holes in the countering jaw. Because the clamping device has a plurality of through holes in the jaws, an accessory (such as a story stick) may be easily removably or fixedly attached to the face of either jaw by placing the accessory to the front face of a jaw and have pins or screws inserted through the rear face of the jaw to tighten the accessory onto the face of the jaw. There is no need to blindly matching the holes on the front face of a jaw with the holes on the accessory or drill a matching hole into the accessory prior to placing it on the jaw.

### RELATED APPLICATION

This application is a Non-provisional Application of Provisional Application Ser. No. 62/670,682 for “Improved Jaw For Straight Edge Clamping Devices” filed on May 11, 2018.

### SUMMARY

A clamp, including but not limited to, a straight edge clamping device with an improved jaw is described. The improved jaw is for a straight edge clamp and/or straight edge bar clamp also referred to as a clamping tool guide.

Past jaw design for clamping tool guides have had blind hole(s) (holes with a bottom(s), as they were not through holes) in the clamping face of the jaws for the purpose of attaching accessories, such as with a story stick. A story stick generally is a simple length of a dowel (a square shape or a rectangular shape in general) with necessary mounting holes or modifications for mounting, often in the length of 8-12 inches. A story stick is designed to be removably attached to the jaw face of a clamp. A story stick is useful as a positioning device that facilitates easy positioning of a clamp or clamping tool guide relative to a guided tool's cutter location when attached to a clamping face of one or both jaws. When such an accessory or a device (such as a story stick) is employed, the ability to set up the clamp's guiding edge position improves for simpler and more accurate locating and various other uses. More specifically, the ability to set up a guide location relative to the clamped work's preferred cut location is remarkably improved.

Previous art required many judicious measurements and marks on a workpiece to account for cutter offset when positioning the tool guide portion of a clamp, or employment of a story stick or a different accessory must be attached from the front face of the jaw, either with an accessory jaw or with screws, fastening its position to the jaw by putting the screws through holes previously made in the story stick, for mounting screws and screwing them into the face of the jaws using blind holes (not through holes in the jaws) provided in the face of a jaw. Note that in order for the story stick to be readily attached to the face of the jaw, the accessory such as a story stick must be prepared previously, with holes with counterbores, to accommodate screw heads, matched to the jaw's blind hole locations. The screw heads had to be set into the story stick with counterbores so that the screw heads did not interfere with the enhanced jaw face (jaw face with installed story stick) engaging of the workpiece.

An alternate means to attach an accessory to the jaw in the prior art was by using an accessory jaw, which is prepared similarly to the story stick so that the accessory jaw with the story stick (or other accessories) may attach to it in the same way. With the accessory jaw's capacity to hold a story stick by various means attached to the face of the jaw. The accessory jaw holding a story stick or other accessory would have to of been prepared previously such that counterbored holes match the locations of provided blind holes on the base jaws. Whichever way, the prior art involved the necessity of careful measuring and marking of workpiece(s), and/or use of extra accessories and extra work involving carefully and accurately drilling and counter boring holes to match the blind hole(s) location(s) on the original primary jaws.

The inventor believes and it shall be noted that clamps related to the clamps described herein, especially all types of clamping tool guides and/or straight edge clamps, have been manufactured for nearly 40 years, and many tool companies have made version of the similar category clamps with many different design variances. However, no one has made a clamp, especially a straight edge clamp, straight edge bar clamp or clamping tool guide with through holes in the jaw, exposing the through holes on both the front clamping face and the rear face of the jaw. The users simply accepted the difficulties of matching the holes on the story stick to the blind hole locations on the jaw face or using accessory jaws or measuring and marking workpieces to account for offset when positioning said clamping tool guides.

Because of the difficulties in attaining and attaching an accessory attachment (such as a story stick), or measuring and marking work to account for cutter offset, there has been a long-felt need for an improved clamp with the jaws' ability to accept accessories where the accessory may be easily attached to a jaw of the clamping mechanism with little or no previous preparation, or without the need for an accessory jaw. In order to overcome the long-felt need for an improved clamping tool guide of all types, the description of the clamp with improved jaws is presented as follows.

The straight edge clamp or clamping tool guide device has a tool guide edge with a clamping mechanism incorporated in its design to removably fix the tool guide to a workpiece. The clamping mechanism portion has a clamping face and rear face of a base jaw and a countering jaw with a clamping face and rear face, Wherein the base jaw and countering jaw oppose each other at the clamping faces. Also, the base jaw and countering jaws both have one or more through holes from its respective clamping face through to its rear face so that a base accessory (such as a story stick) may be attached to either jaw(s) utilizing the through holes in the clamping face(s) jaw(s)′. Using screws entering through the rear face to the front clamping face, screwing into the accessory story stick, and by this means removably attaches it to the face of the base jaw(s).

The front base jaw with or without the base accessory and the countering base jaw with or without the countering accessory are used to removably hold a workpiece. It is possible to attach only a single accessory (such as a story stick) to either the base jaw or the countering jaw. Moreover, either or both the base jaw and the countering jaw may have one or more hole(s) to accommodate screw(s) to hold accessories in place. A rectangular shaped or an ellipse shaped pin, with a matching shaped insert in the story stick, may be used instead of multiple screws to hold a story stick in place securely.

Because the clamping device has a plurality of through holes in the jaws, an accessory (such as a story stick) may be easily, removably or fixedly attached to a face of the jaw by placing the accessory (such as a story stick) to a front face of a jaw and have pins or screws be inserted through the rear face of the jaw without blindly matching the holes on the front face of a jaw. As an example, a story stick may be held against the front base face of the base jaw by the workman with a hand and screw one or more screws on the story stick from the rear base face through the through holes provided in the base jaw; there is no need to carefully align the holes to secure that the hole in the story stick match the holes in the jaw. Similarly, a story stick may be attached to a front countering face of the countering jaw by simply placing the story stick on the front countering face and screwing one or more screws on the story stick from the rear countering face through the through holes provided in the countering jaw.

Because of the innovative features in the use of through holes in the jaws, accessories (such as a story stick) may be quickly and effortlessly attached to a face of a jaw using pins or screws or bolts or various other means of holding such accessories utilizing the visible holes from the rear surface. When one or more pin(s) or screw(s) are used, the through hole(s) does not have to have any threads or accepting means, except to have through hole(s) continuous from one face to the other of each jaw, front or clamping face to the rear face. As an alternative design, at least one of the through holes in the base jaw or the countering jaw may have a spiral or a threaded surface to accept a screw or a threaded bolt. A beneficial feature also is that the through holes do not have to have any threads or a spiral to accommodate screws or bolts, because the mechanical pull of the screw onto the story stick will be sufficient to hold the story stick securely on the face of the jaw.

The preferred embodiment of the clamp described herein is a straight edge clamp or a straight edge bar clamp, both of which are embodiments of a clamping tool guide. They all have a tool guide portion and a clamping mechanism that may be slidably moved along the tool guide portion in the direction of the tool's guiding edge's, wherein the clamping mechanism can be fixedly attached to the guide's body while the clamp surfaces engage and hold a workpiece. In this way the guide portion is held securely so that any number of potential tools can use the guide portions to direct its action, cutting, marking, et cetera in a straight line along a workpiece. Moreover, a straight edge clamp may have a jaw lock that locks and releases the countering jaw so that the countering jaw may be slidably moved along the clamp surface. Improves utility of all embodiments of clamping tool guides.

### BRIEF DESCRIPTION OF THE DRAWINGS

These and other features, aspects and advantages of the improved jaw for straight edge clamping devices will become better understood with reference to the accompanying drawings, wherein:

FIG. 1: a straight edge clamping device,

FIG. 2: the straight edge clamping device with jaws and through holes in the jaws,

FIG. 3: the straight edge clamping device with the story stick and screws ready to be installed,

FIG. 4: the straight edge clamping device with the story stick installed,

FIG. 5: the straight edge clamping device with the story stick installed clamped to a workpiece,

FIG. 6: the straight edge clamping device with the installed story stick cut by a circular saw,

FIG. 7: the straight edge clamping device with the cut story stick being used to position straight edge clamping device for a cut,

FIG. 8: the straight edge clamping device with the cut story stick in position showing a partial cut on the workpiece, and

FIG. 9: the straight edge clamping device wherein the story stick is in process of being installed by screws.

### DETAILED DESCRIPTION EMBODIMENTS OF THE INVENTION

A clamp with improved and enhanced jaws is described in detail. More specifically, the clamp described is a straight edge clamp, often referred to as a straight edge bar clamp.

To make attachment of accessories more easily accomplished, especially a story stick, this new jaw configuration is adjusted to include unobstructed through holes and hole faces to allow for screws to be projected through the jaw body from rear to front. As such the protruding tip of the screw can engage and hold the story stick while tightening from the rear of the jaw. In this way the story sticks and other accessories are pulled flush against front faces of the jaws. In this way the accessory can be attached with little or no preparation, enabling a simple square dowel or like accessories to be easily attached with no previously prepared and aligned holes. The task of attaching a story stick will be much easier. The story stick when positioned as described on the face of a jaw may assist in aligning the straight edge clamp edge to a preferred guiding position.

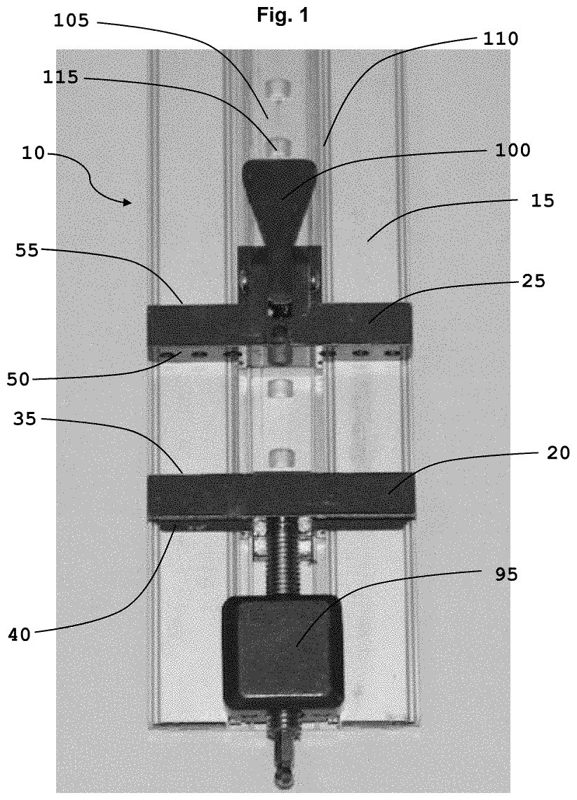

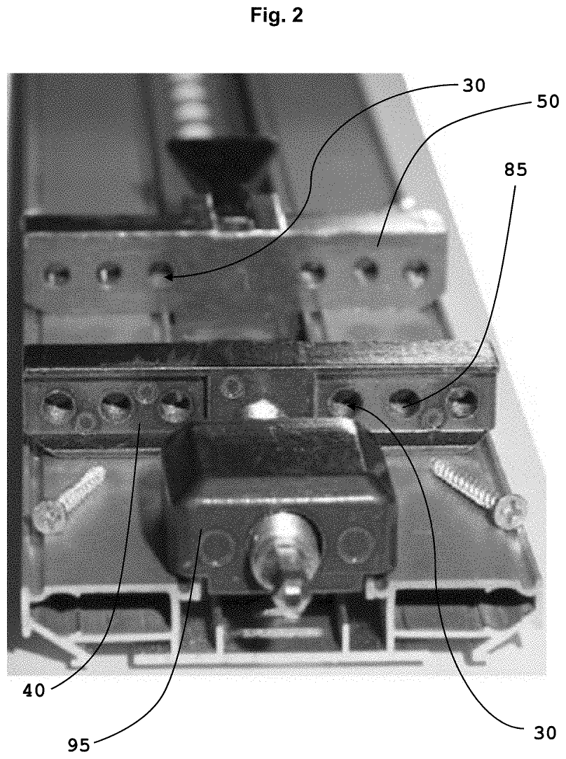

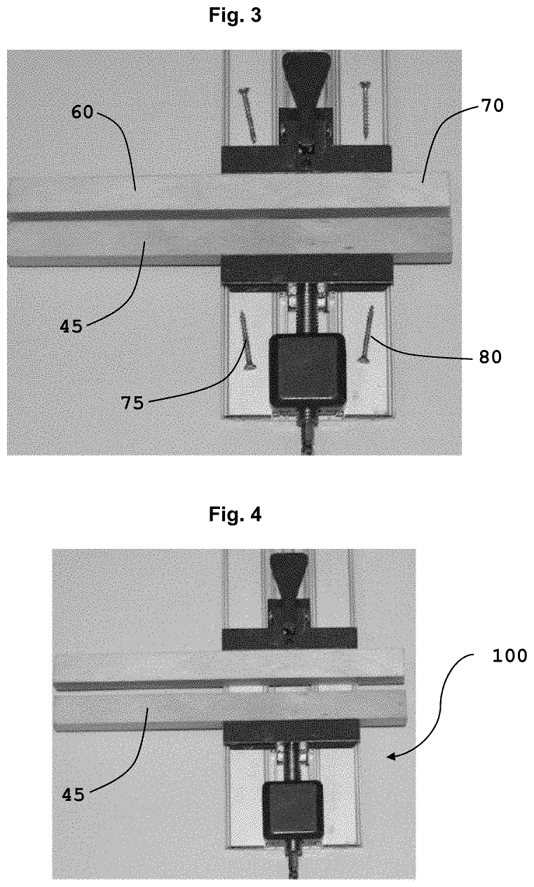

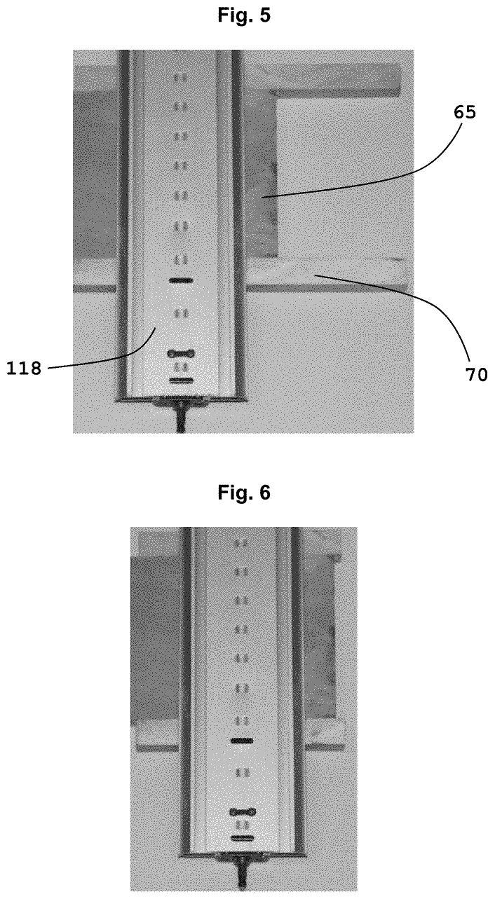

Referring to FIGS. 1 and 2, a clamping device 10 with a clamp surface 15 with a base jaw 20 and a countering jaw 25 attached to the clamp surface 15 is shown. The base jaw 20 has one or more through holes 30 from a front base face 35 to a rear base face 40 so that a base accessory 45 (shown in FIG. 3) may be attached to the base jaw 20 using the through holes 30 in the base jaw 20. The countering jaw 25 also has one or more through holes 30 from a front countering face 50 to a rear countering face 55 so that a countering accessory 60 (shown in FIG. 3) may be attached to the countering jaw 25 using the through holes 30 in the countering jaw 25. The front base face 35 with or without the base accessory 45 and the front countering face 50 with or without the countering accessory 60 are used to removably hold a workpiece 65 (shown in FIG. 5).

Because the clamping device 10 has a plurality of through holes 30 in the jaws 20, 25, an accessory 45, 60 (such as a story stick 70) may be easily removably or fixedly attached to a face of the jaw by placing the accessory 45, 60 to the front face 35, 50 of a jaw and have pins 75 or screws 80 inserted through a rear face 40, 55 of the jaw without blindly matching or carefully aligning the holes in the accessory 45, 60 on the front face 35, 50 of the jaw 20, 25. As an example, a story stick 70 may be attached to the front base face 35 of the base jaw 20 by simply placing the story stick 70 on the front base face 35 and screwing one or more screws 80 on the story stick 70 from the rear base face 40 through the through holes 30 provided in the base jaw 20. Likewise, a story stick 70 may be attached to the front countering face 50 of the countering jaw 25 by simply placing the story stick 70 on the front countering face 50 and screwing one or more screws 80 on the story stick 70 from the rear countering face 55 through the through holes 30 provided in the countering jaw 25.

Because of the innovative features in using the through holes 30 already set in the jaws 20, 25, accessories 45, 60 (such as story sticks 70) may be quickly attached to the face of a jaw using pins or screws or bolts or various other means of holding such accessories entered through the visible holes 30 from the rear faces 40, 55. When one or more pins is used, the through hole does not have to have any threads or accepting means on the through holes 30 (that is, the through hole may have a smooth surface 85 as shown in FIG. 2). As an alternate design, at least one of the through holes 30 in the base jaw 20 or the countering jaw 25 may have a spiral or a threaded surface (not shown) to accept a screw 80 or a threaded bolt.

A preferred embodiment of the claim described herein is a straight edge clamp 90, also referred to as a straight edge bar clamp. The straight edge clamp 90 may have a base mount 95 fixedly attached to the clamp surface 15 so that the base jaw 20 may be slidably moved along the clamp surface 15. In addition, the straight edge clamp 90 may also have a jaw lock 100 that locks and releases the countering jaw 25 so that the countering jaw 25 may be slidably moved along the clamp surface 15 utilizing a track 105 or a groove 110 on the clamp surface 15. As shown in FIG. 1, the clamp surface 15 may also have stopping indentations 115 to securely hold the countering jaw 25 in place, preventing slippage of the countering jaw 25.

Referring to FIGS. 3 and 4, the clamping device with a base accessory 45 and a countering accessory 60 about to be mounted on the front base face 35 and the rear base face 40, respectively, using screws 80 (the screws may be pins 75 or nails or needles or similar holding tool). The preferred means of attaching the accessories to the jaws is using the screws 80, because the use of pins 75 may require a pin accepting device (not shown) designed in the accessory. However, a pin may be a nail (not shown) that is used to pierce the accessory through the through holes 30 in the base jaw 20 or in the countering jaw 25. FIG. 4 shows a base accessory 45 and a countering accessory 60 mounted on the front base face 35 and the rear base face 40, respectively, using screws 80, wherein the screw heads are set into (sunk in) the rear base face 40 and the rear countering face 55 so the screw heads are not visible.

FIGS. 5 and 6 show the underside 118 of the clamping device. The clamping device 10 has a workpiece 65 tightly held between the base accessory 45 and the countering accessory 60 which are mounted on the front base face 35 and the front countering face 50, respectively. FIG. 6 shows a straight edge clamping device 120 with story stick 70 cut by a circular saw (a circular saw is not shown).

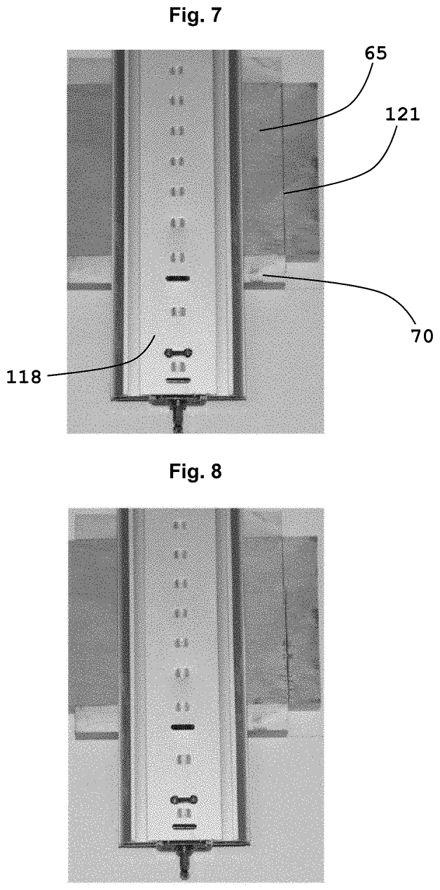

FIG. 7 shows the underside of the straight edge clamping device 120 with a story stick 70 already cut used to position straight edge clamping device 120 to be used for a cut along a cutline 121 on the workpiece 65. FIG. 8 shows the straight edge clamping device 120 with FIG. 7 showing a partial cut with a saw along a cutline 121 on the workpiece 65.

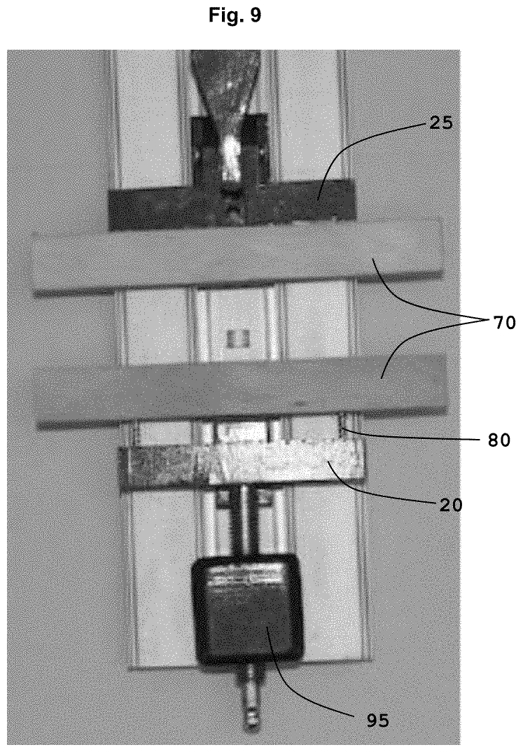

FIG. 9 shows the straight edge clamping device 120 wherein the story stick 70 is in process of being installed by screws 80 that are inserted from the rear of the jaws 20, 25 through the jaws body and out the face of the jaws 35, 50 to penetratingly engage the story stick 70. The screws 80 are shown partially tightened to illustrate the working of the clamp 10. The screws 80 in FIG. 9 only need to be tightened more to pull the story stick 70 against the face of the jaws 35, 50.

While the invention has been shown and described with reference to different embodiments thereof, it will be appreciated by those skilled in the art that variations in form, detail, compositions and operation may be made without departing from the spirit and scope of the invention. For example, the through holes 30 may be placed in the base jaw 20 and not the countering jaw 25, or vise versa. Moreover, the through holes in the jaws 25, 30 may not need to be circular.

What is claimed is:

1. A clamping device comprising:
a clamp surface with a base jaw and a countering jaw attached to the clamp surface,
wherein the base jaw has a through hole from a front base face to a rear base face so that a base accessory may be attached to the base jaw using the through hole,
wherein the countering jaw has a front countering face and a rear countering face so that the front countering face and the front base face are used to removably hold a workpiece.

2. The clamping device of claim 1 wherein the base accessory may be attached to the front base jaw using the through hole with a pin introduced from the rear base face.

3. The clamping device of claim 2 wherein the pin is a screw.

4. The clamping device of claim 1 wherein the through hole in the base jaw has a smooth hole surface.

5. The clamping device of claim 1 wherein the through hole in the base jaw has a spiral or a threaded surface to accept a screw or a threaded bolt.

6. The clamping device of claim 4 wherein the clamping device is a straight edge.

7. A clamping device comprising:
a clamp surface with a base jaw and a countering jaw attached to the clamp surface,
wherein the base jaw has a through hole from a front base face to a rear base face so that a base accessory may be attached to the base jaw using the through hole in the base jaw,
wherein the countering jaw has a through hole from a front countering face to a rear countering face so that a countering accessory may be attached to the countering jaw using the through hole in the countering jaw,
wherein the front base face with or without the base accessory and the countering face with or without the countering accessory are used to removably hold a workpiece.

8. The clamping device of claim 7 wherein the base accessory may be attached to the front base jaw using the through hole with a base pin introduced from the rear base face and the countering accessory may be attached to the front countering jaw using the through hole with a countering pin introduced from the rear countering face.

9. The clamping device of claim 8 wherein at least one of the base pin and the countering pin is a screw.

10. The clamping device of claim 7 wherein at least one of the through hole in the base jaw and the through hole in the countering jaw has a smooth hole surface.

11. The clamping device of claim 7 wherein at least one of the through hole in the base jaw and the through hole in the countering jaw has a spiral or a threaded surface to accept a screw or a threaded bolt.

12. The clamping device of claim 10 wherein the clamping device is a straight edge.

13. A clamping device comprising:
a clamp surface with a base jaw and a countering jaw attached to the clamp surface,
wherein the base jaw has a plurality of through holes from a front base face to a rear base face so that a base accessory may be attached to the base jaw using the through holes in the base jaw,
wherein the countering jaw has a plurality of through holes from a front countering face to a rear countering face so that a countering accessory may be attached to the countering jaw using the through holes in the countering jaw, and
wherein the front base face with or without the base accessory and the countering face with or without the countering accessory are used to removably hold a workpiece.

14. The clamping device of claim 13 wherein the base accessory may be attached to the front base jaw using the plurality of through holes with one or more base pins introduced from the rear base face and the countering accessory may be attached to the front countering jaw using the plurality of through holes with one or more countering pins introduced from the rear countering face.

15. The clamping device of claim 14 wherein at least one of the base pins and the countering pins is a screw.

16. The clamping device of claim 13 wherein at least one of the through holes in the base jaw and the through holes in the countering jaw has a smooth hole surface.

17. The clamping device of claim 13 wherein at least one of the through holes in the base jaw and the through holes in the countering jaw has a spiral or a threaded surface to accept a screw or a threaded bolt.

18. The clamping device of claim 16 wherein the clamping device is a straight edge.

19. The clamping device of claim 18 further comprises of a base mount fixedly attached to the clamp surface so that the base jaw may be slidably moved along the clamp surface.

20. The clamping device of claim 19 further comprises of a jaw lock that locks and releases the counting jaw so that the countering jaw may be slidably moved along the clamp surface.
